(19) United States
(12) Patent Application Publication
(10) Pub. No.: US 2019/0078366 A1
(43) Pub. Date: Mar. 14, 2019

(54) LIGHT WEIGHT TWO PIECE FRAMELESS DOOR MODULE WITH ADJUSTMENT FEATURES

(71) Applicant: MAGNA CLOSURES INC., Newmarket (CA)

(72) Inventors: Yufei LU, Richmond Hill (CA); Milos PAVLOVIC, Kleinburg (CA); Eugene KIM, North York (CA)

(21) Appl. No.: 16/122,268

(22) Filed: Sep. 5, 2018

Related U.S. Application Data
(60) Provisional application No. 62/555,715, filed on Sep. 8, 2017.

(51) Int. Cl. E05D 15/16; E05F 11/48; B60J 5/04

(52) U.S. Cl. CPC E05D 15/165; E05Y 2900/55; B60J 5/0419; E05F 11/483

(57) ABSTRACT

A carrier module including a pair of carrier members operably coupled to one another via at least one cable is provided. The carrier members are configured for substantially free movement relative to one another to facilitate installation of the carrier members into an internal door cavity through an opening formed in the inner panel, wherein at least one of the carrier members is adjustable along at least one of cross-vehicle, aft/forward, and up/down directions.

### CROSS-REFERENCE TO RELATED APPLICATION

This application claims the benefit of U.S. Provisional Application Ser. No. 62/555,715, filed Sep. 8, 2017, which is incorporated herein by reference in its entirety.

### FIELD

The present disclosure relates generally to vehicle door assemblies, and more particularly to a carrier module of a door assembly having a pair of carrier members detached from one another and having adjustment features allowing the carrier module to be adjusted along three axes.

### BACKGROUND

This section provides background information related to the present disclosure which is not necessarily prior art.

In many motor vehicle door assemblies, an outer sheet metal door panel and an inner sheet metal door panel are connected together to define an internal door cavity therebetween. An equipment module or sub-assembly, commonly referred to as a carrier module, or simply carrier, is often mounted to the inner door panel within the internal door cavity. The carrier typically functions to support various door hardware components, including window regulator rails configured to support lifter plates for selectively slidable movement therealong. The lifter plates are fixed to a window to cause the window to slide up and down therewith along the direction of guide channels within the window regulator rails.

In vehicles that require so called “frameless” doors, such as are commonly used on convertibles, the window regulator rails and lifter plates are typically bulky, heavy, complex metal components due to the need for the window to be made adjustable and to resist deflection. Proper adjustment of the window, such as during assembly, is crucial to ensure the window follows the desired path while being opened and closed to avoid window jams and to perfect a seal when closed. Further, the ability of the window to resist flexing or bending deflection, such as while being placed under a load during a door closing/slamming event or in an up-stall condition, is important to avoid glass breakage or misalignment. As such, the carrier and the window regulator components, such as the window regulator rails and lifter plates, need to be robust and relatively stiff to withstand the forces and energy encountered during use, and to withstand the stresses and bending moments on the window regulator rails and lifter plates/glass interface. As such, the carrier, window regulator rails and lifter plates are typically formed of steel and heavy die-cast components in order to withstand the challenging environment of a frameless door. Unfortunately, the metal components are not only bulky and heavy, but are also costly in manufacture.

In view of the above, there is a need to provide a carrier module for a frameless door that is, readily adjustable along X, Y and Z axes, lightweight, has a small outer envelop, while being economical in manufacture and assembly, relative to non-adjustable metal components typically used for such frameless door applications.

### SUMMARY

This section provides a general summary of the disclosure and is not intended to be considered a complete and comprehensive listing of the disclosure's full scope or all of its aspects, advantages, objectives and/or features.

It is an objective of the present disclosure to provide a motor vehicle door assembly which addresses at least those issues discussed above.

It is a related objective of the present disclosure to provide a carrier module which addresses at least those issues discussed above for use with any door assembly of any model of motor vehicle.

In accordance with one aspect of the disclosure, the present disclosure is directed to a carrier module for a motor vehicle having inner and outer panels defining a door panel structure with an internal door cavity. The carrier module includes a pair of carrier members, with each carrier member extending lengthwise between opposite first and second ends. The carrier members are operably coupled to one another via at least one cable and are configured for substantially free movement relative to one another to facilitate installation of the carrier members into the internal door cavity. At least one of the carrier members has at least one adjuster allowing the carrier member to be adjusted along at least one of aft/forward, up/down and cross-vehicle directions.

In accordance with one aspect of the disclosure, the at least one carrier member has a window regulator rail and a lifter plate configured for reciprocating movement along the window regulator rail between the first and second ends. A window mount bracket is coupled to the lifter plate, wherein the window mount bracket is configured for fixed attachment to a window. The lifter plate and window mount bracket are adjustably moveable relative to one another to provide the at least one of aft/forward and up/down adjustment.

In accordance with one aspect of the disclosure, an adaptor can be disposed between the lifter plate and the window mount bracket. The lifter plate and the adaptor are adjustably moveable relative to one another to provide the at least one of aft/forward and up/down adjustment.

In accordance with one aspect of the disclosure, the adaptor can be provided with one of a spring lock finger and a pocket, wherein the spring lock finger is configured to releasably lock and fix the window mount bracket against relative movement with the adaptor.

In accordance with one aspect of the disclosure, the window mount bracket can be provided having a mount pocket configured for fixed receipt of an edge of the window therein, thereby doing away with the need to provide openings in the window.

In accordance with one aspect of the disclosure, the at least one carrier member and the window regulator rail can be formed as a single piece of plastic material, thereby being relatively lightweight and economical in manufacture and assembly.

In accordance with one aspect of the disclosure, at least one of the lifter plate and the window mount bracket can be formed of plastic, thereby being relatively lightweight and economical in manufacture and assembly.

In accordance with one aspect of the disclosure, the at least one carrier member has a mount bracket adjacent one of the first and second ends, wherein the mount bracket can be configured for attachment to a door panel structure. The at least one carrier member and the mount bracket are configured to be adjustably moveable relative to one another to provide selective adjustment in the cross-vehicle direction.

In accordance with one aspect of the disclosure, the at least one carrier member has a laterally extending adjustment rail and a slide adjuster. The adjustment rail can be provided having a plurality of teeth and the slide adjuster can be operably coupled to the mount bracket. The slide adjuster can be formed having at least one pawl configured for moveable adjustment along the plurality of teeth of the adjustment rails to provide cross-vehicle adjustment of the carrier member.

In accordance with one aspect of the disclosure, the at least one carrier member has an adjustment rail extending laterally outwardly therefrom and a pinion gear supported for rotation by the adjustment rail. The mount bracket can be provided having a plurality of teeth configured in meshed engagement with the pinion gear, wherein selective rotation of the pinion gear causes the at least one carrier member and the mount bracket to be adjustably moveable relative to one another in the cross-vehicle direction.

In accordance with another aspect of the disclosure, the present disclosure is directed to a door assembly for a motor vehicle configured to include an outer panel, an inner panel, and a carrier module. The outer panel and the inner panel, when connected together, form a door panel structure that is configured to define an internal door cavity. The carrier module is configured to include a pair of carrier members operably coupled to one another via at least one cable. The carrier members are configured for substantially free movement relative to one another to facilitate installation of the carrier members into the internal door cavity through the opening formed in the inner panel. At least one of the carrier members is formed substantially of plastic, thereby being economical in construction and relatively lightweight.

In accordance with another aspect of the disclosure, the at least one carrier member of the door assembly can be formed as a B-pillar carrier member and entirely of plastic.

In accordance with another aspect of the disclosure, the lifter plate of the door assembly can be provided to be adjustable along two separate axes, including an aft/forward, horizontal axis and an up/down, vertical axis.

In accordance with another aspect of the disclosure, a window mount bracket of the door assembly can be configured for fixed attachment to a window without fasteners extending through the window, wherein the lifter plate and the window mount bracket can be configured for adjustable attachment to one another for relative adjustable movement with one another to provide the adjustment along the aft/forward, horizontal axis and the up/down, vertical axis.

In accordance with another aspect of the disclosure, the at least one carrier member of the door assembly can be provided to be adjustable in cross-vehicle direction.

In accordance with another aspect of the disclosure, a mount bracket of the door assembly can be configured for attachment to the inner panel, wherein the at least one carrier member and the mount bracket can be configured for relative movement with one another to provide the cross-vehicle direction adjustment.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 illustrates a motor vehicle with a door assembly;

FIG. 2 illustrates a carrier module and barrier of the door assembly of FIG. 1 constructed in accordance with one aspect of the disclosure;

FIG. 3 illustrates the carrier module of FIG. 2 shown assembled to the door assembly of FIG. 1 with the barrier folded back;

FIG. 4 illustrates the carrier module and barrier of FIG. 2 shown fully assembled to the door assembly of FIG. 1;

FIG. 5 illustrates a side elevation view of the carrier module of FIG. 2 with a window assembled thereto and electronic components removed therefrom;

FIG. 6 illustrates an end elevation view of the carrier module of FIG. 5;

FIG. 7 illustrates an enlarged partial view of the carrier module of FIG. 5 showing an adjustment feature thereof;

FIG. 8 illustrates a view similar to FIG. 7 with a portion of the adjustment feature removed;

FIG. 9 illustrates an enlarged partial view of the carrier module of FIG. 5 showing an alternative adjustment feature to the adjustment feature of FIG. 7;

FIG. 10 illustrates a view similar to FIG. 9 with a lock nut of the adjustment feature removed;

FIG. 11 illustrates a side elevation view of a lifter plate, glass mount bracket adjustment feature of the carrier module of FIG. 5;

FIG. 12 illustrates a view similar to FIG. 11 of an opposite side of the lifter plate, glass mount bracket adjustment feature;

FIG. 13 illustrates a front perspective view of an alternate lifter plate, glass mount bracket adjustment feature to the lifter plate, glass mount bracket adjustment feature of FIG. 11;

FIG. 14 illustrates a rear perspective view of the lifter plate, glass mount bracket adjustment feature of FIG. 13;

FIG. 15 illustrates a front perspective view of another alternate lifter plate, glass mount bracket adjustment feature to the lifter plate, glass mount bracket adjustment feature of FIG. 11; and

FIG. 16 illustrates a rear perspective view of the lifter plate, glass mount bracket adjustment feature of FIG. 15.

### DETAILED DESCRIPTION OF PRESENTLY PREFERRED EMBODIMENTS

The following is a detailed description of example embodiments of a door assembly and carrier module therefor and of the type configured to be installed within an internal door cavity of a motor vehicle door assembly, including a frameless vehicle door such as would be provided on convertible and luxury style vehicles. A frameless vehicle door as known in the art is a vehicle door that does not include a guiding or surrounding structure extending from the vehicle door panels to frame the vehicle window, as known for framed vehicle doors. As such, a frameless vehicle door, as compared with a framed vehicle door does not include side supporting structure(s) to assist with guiding and/or sealing the side edges of the window when the window is extending or retracting, nor an upper supporting portion extending between such side supporting structure(s) for guiding and sealing the top edge of the window when the window is in its fully extended position. It is understood that some support may be provided to the window along the a portion of travel of the vehicle window, such as for example and without limitation from a rear view mirror support extending from a forward top portion of the vehicle door panel, however the alignment and path of travel of the window in a frameless vehicle door will be generally controlled by the carrier module in a manner as will be described herein. The carrier module embodiment disclosed in accordance with one aspect of the disclosure includes a pair of carrier members with a pair of window regulator rails integrally formed with the carrier members, wherein the carrier members are operably coupled to one another via flexible members, such as cables and/or conduits, thereby allowing the carrier members and associated window regulator rails to be independently and freely moved and positioned relative to one another. At least one of the carrier members is fully adjustable along three axes, thereby allowing for adjustment along a cross-vehicle direction, aft/forward direction, and up/down direction. These example embodiments are provided so that this disclosure will be thorough, and will fully convey the scope to those who are skilled in the art. It will be apparent to those skilled in the art that specific details need not be employed, that the example embodiments may be embodied in many different forms, and thus, the disclosed embodiments should not be construed to limit the scope of the disclosure. It is to be further recognized that well-known processes, well-known device structures, and well-known technologies are not described in detail, as they will be readily understood without explanation by those skilled in the art.

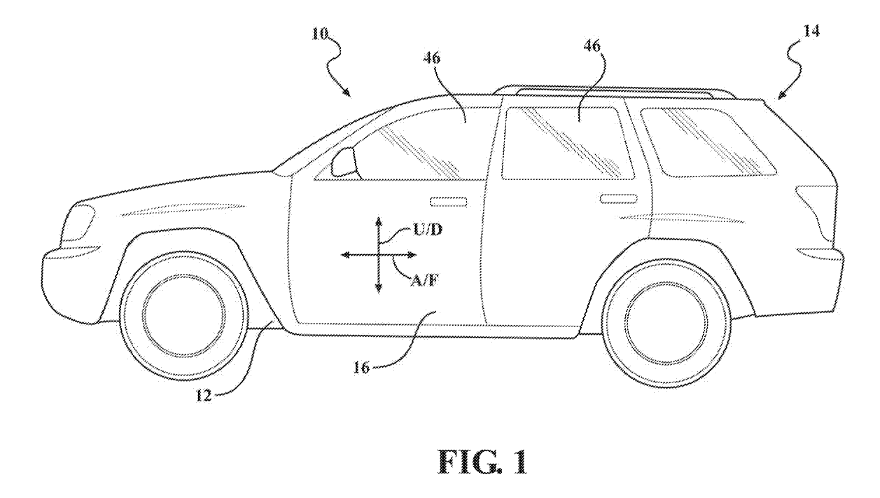

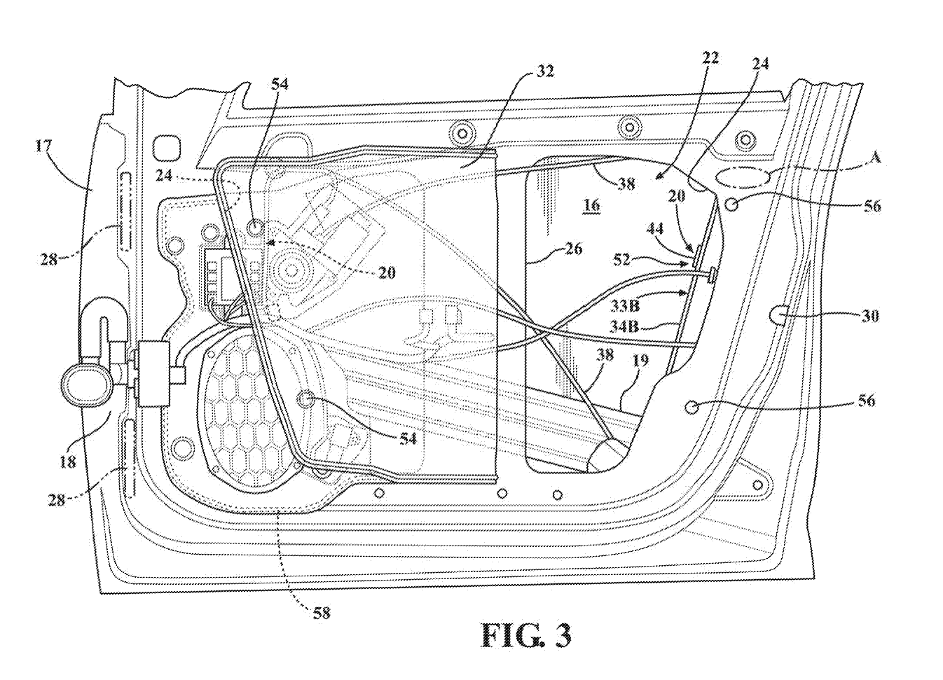

Reference is made to FIG. 1, which shows a door assembly 10 mounted to a body 12 of a motor vehicle 14. The door assembly 10 includes an outer panel 16, an inner panel 18 (FIG. 3), an intrusion member 19 and a frameless door carrier module, referred to hereafter simply as carrier module 20, shown constructed in accordance with one presently preferred aspect of the disclosure. The production, assembly/adjustment and operation of the door assembly 10 is facilitated and enhanced directly as a result of the configuration and adjustability of the carrier module 20, as discussed further hereafter, and as will be readily appreciated by one skilled in the art.

The outer panel 16 forms at least part of the exterior surface of the door assembly 10. The inner panel 18 provides a structural member for the mounting of one or more trim pieces that form an inner surface of the door assembly 10. Some of the inner panel 18 may itself also form part of the inner surface of the door assembly 10, if desired. The outer and inner panels 16, 18 are connected together to provide a door panel structure 17 that forms an internal door cavity 22 (FIG. 3) that contains various components of the door assembly 10, including at least a portion of the carrier module 20. To facilitate assembly of the components into the cavity 22, the inner panel 18 has at least one, and shown as a pair of openings 24, by way of example and without limitation. The openings 24 are shown as being formed on opposite sides of the inner panel 18 with a central support member or rail 26 extending therebetween. The central support rail 26 can be formed as an integral, monolithic piece of material with the inner panel 18, thereby rendering the inner panel 18 economical in manufacture and enhancing the structural integrity, strength and side impact resistance of the inner panel 18. Due to the ability of at least some of the carrier module components, discussed separately hereafter, to be moved relative to one another, and due to the relatively small size of the individual components of the carrier module 20, in comparison to the size of the assembled carrier module 20, as discussed in more detail below, and further due to the ability to maintain at least a portion of the carrier module 20 externally from the internal door cavity 22, the size of the individual openings 24 needed in the inner panel 18 for assembly of the carrier module 20 can be minimized. As such, the amount and area of material forming the inner panel 18 and/or rail 26 can be maximized, thereby increasing the side impact strength of the inner panel 18 relative to inner panels having substantially larger central openings and reduced area.

The outer and inner panels 16, 18 may be made from any suitable material or combination of materials. For example, the outer and inner panels 16, 18 may both be made from a suitable metal (e.g. a suitable steel). In another example, the outer panel 16 may be made from a suitable polymeric or composite material (e.g. fiberglass) and the inner panel may be made from a suitable metal, by way of example and without limitation.

A pair of hinges 28 are connected to door panel structure 17 and pivotally mount a front end of door panel structure 17 (and door assembly 10) to the vehicle body 12. A door latch 30 is mounted to the rear end of door panel structure 17 to permit the releasable closure of door assembly 10 against vehicle body 12. Hinges 28 and door latch 30 act as force transfer members through which forces in door assembly 10 are transmitted to vehicle 14. Such forces include, for example, side-impact forces from another vehicle or object colliding with the vehicle 14. Hinges 28 act to also allow the door assembly 10 to pivot relative to the vehicle body 12 when door assembly 10 is released from door latch 30.

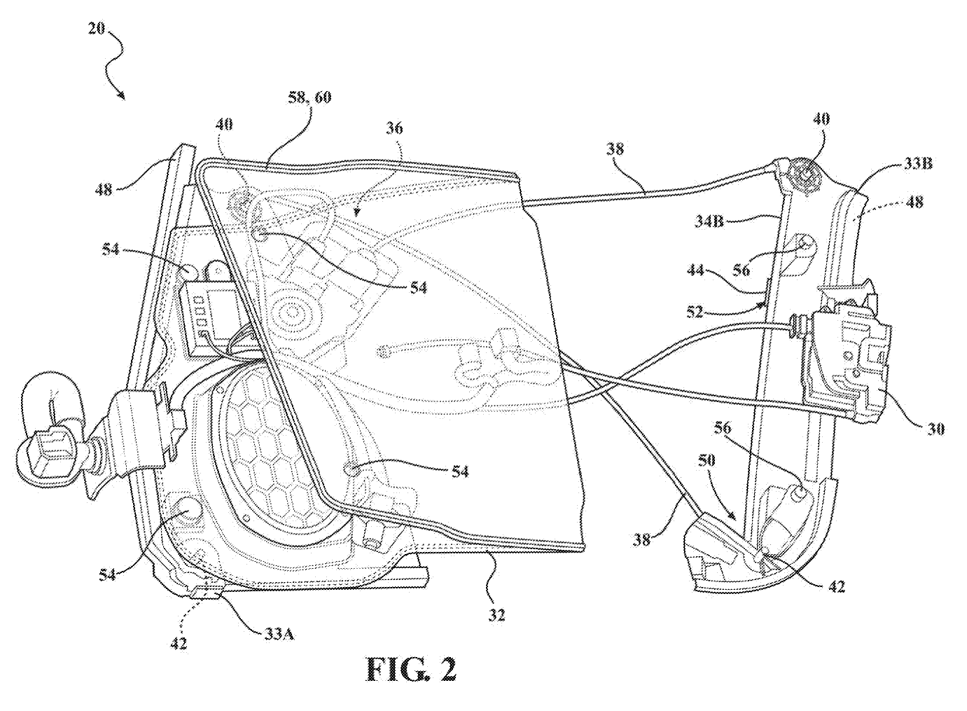

The carrier module 20 is shown to include a barrier member, shown as being a collapsible barrier member 32, by way of example and without limitation, a pair of respective A and B-pillar carrier members 33A, 33B providing a pair of window regulator rails, including, respectively, an A-pillar rail 34A and a B-pillar window regulator rail 34B, and a plurality of door hardware components operably mounted to the carrier members 33A, 33B. In this non-limiting example, at least some of the door hardware includes a power-operated window regulator 36 having an electric motor-driven cable 38, a pair of upper pulleys 40 and lower pulleys 42 (FIG. 2), a pair of lifter plates 44 for moving a window 46 upwardly and downwardly within a pair of glass run channels 48, wherein the glass run channels 48 can be formed integrally as a single piece of material with the A and B-pillar carrier members 33A, 33B, such as in a molding operation, by way of example and without limitation. Further, to facilitate adjustment and proper alignment of the door carrier module 20 and window 46 carried thereby for smooth sliding motion between opened and closed positions, and to ensure proper sealing of the window 46 while in the closed position, the B-pillar carrier member 33B, constructed in accordance with another aspect of the disclosure, includes at least one, and shown as a pair of adjustment features 50, 52, wherein the first adjustment feature 50 allows for adjustment in a lateral, cross-vehicle direction, from a driver side of the vehicle toward a passenger side, and vice-versa, as indicated by arrow C/V in FIG. 6, which corresponds to a direction in-and-out of the page of FIG. 1, while the second adjustment feature 52 allows for adjustment in an aft/forward direction, from the front of the vehicle toward the back of the vehicle, and vice-versa, and in an up/down direction, from the top of the vehicle toward the bottom of the vehicle, and vice-versa, as indicated by respective arrows A/F and U/D of FIG. 1. Accordingly, the first and second adjustment features 50, 52 allow for adjustment along 6 directions corresponding to Cartesian axes X, Y (corresponding to A/F and U/D directions) and Z (corresponding to C/V direction), as discussed in more detail hereafter. Other hardware components shown are well understood by those skilled in the art, and thus, need no explanation, in addition to other components that can be provided, but are not shown.

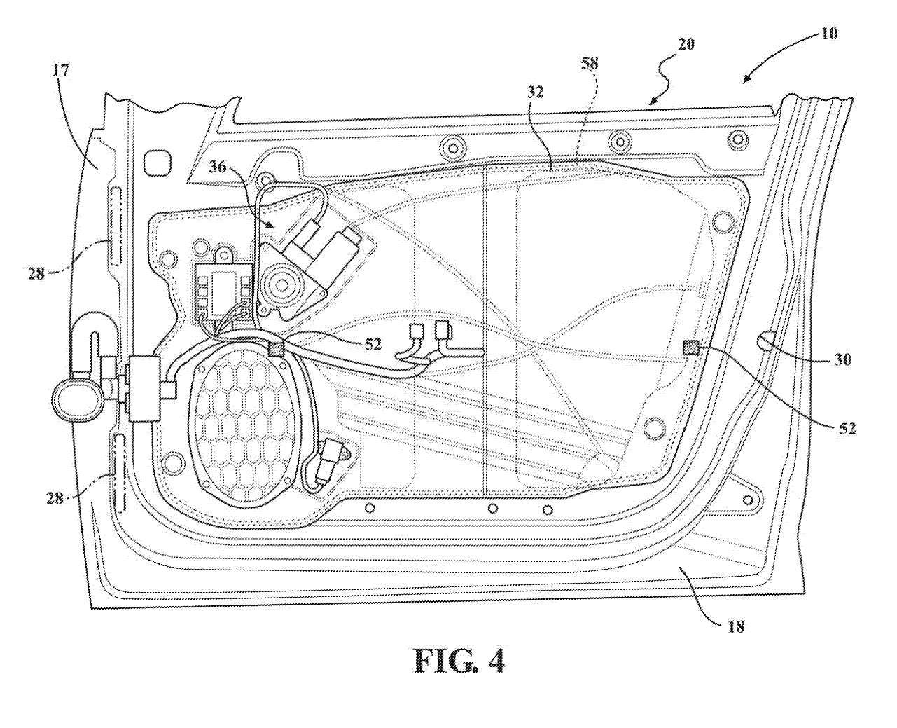

In accordance with a non-limiting embodiment, barrier member 32, intended to function both as a fluid (water) barrier and as a sound barrier, can be formed of any suitable fluid/sound barrier material, as desired, in order to meet the necessary specifications. Further, in order to facilitate assembly, including ensuring the barrier member 32 is properly located and fixed in sealed relation relative to the inner panel 18, the barrier member 32 can be formed with locating features 54, shown by way of example as female recesses, configured for mating engagement with corresponding locating features 56, shown by way of example an male protrusions (FIGS. 2-4), on at least one of the separate carrier members 33A, 33B. The locating features 54, 56 can be formed to provide a snug, interference fit with one another.

In accordance with a further non-limiting embodiment, B-pillar carrier member 33B can be constructed entirely of plastic, thereby being relatively lightweight as compared to a similar structure made of metal, e.g. steel, and also being economical in manufacture, such as via a molding process, by way of example and without limitation, as well as being rigid and durable. The construction of the B-Pillar carrier member 33B, (and/or the A-Pillar carrier member 33A), up till the disclosure and findings herein, are typically known in the art to not be constructed entirely, or even substantially from plastic, due to the high loads placed on the carrier members 33A, 33B, such as can be amplified via movement of the window 46. However, providing a reinforced plastic structure of the B-Pillar carrier member 33B, despite additional reinforcing plastic material, such as in the form of reinforcing ribs and/or reinforcing metal members, to manage the stress can still provide weight and cost savings over traditional structures made entirely of metal. To enhance the structural rigidity of the carrier member 33B, the carrier member 33B can be molded having plastic reinforcement ribs in predetermined locations. Further yet, if needed for the intended application, the carrier member 33B can be molded having one or more metal reinforcement members, such as steel, by way of example and without limitation.

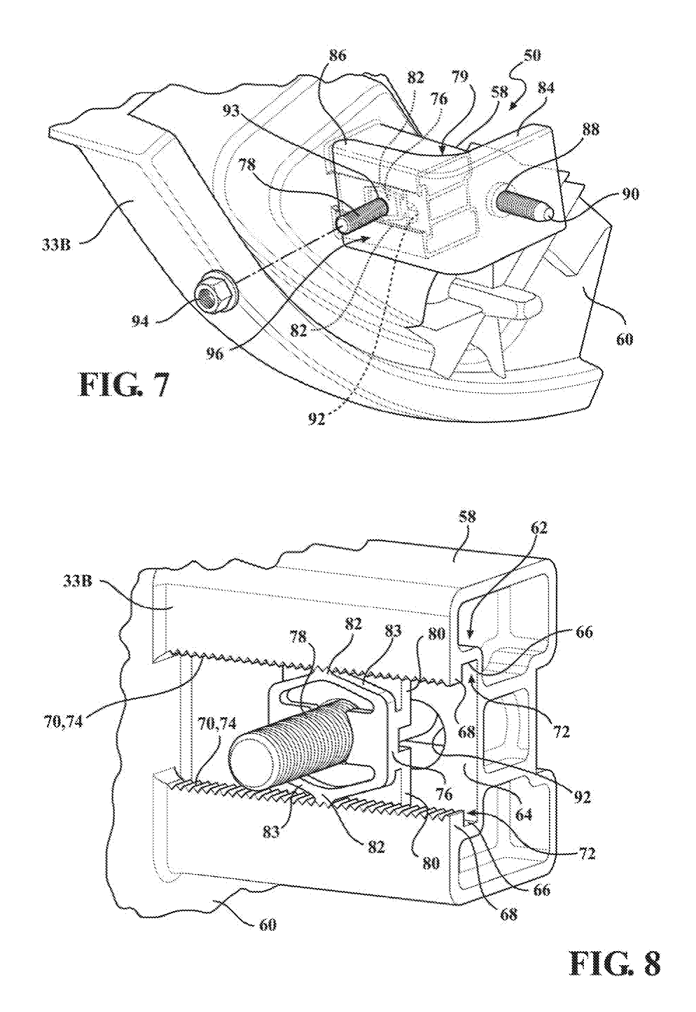

In accordance with a yet further non-limiting embodiment, B-pillar carrier member 33B can be constructed having the pair of adjustment features 50, 52 coupled thereto, either directly or operably via intervening components, such as brackets, by way of example and without limitation. As best shown in FIGS. 7 and 8, the first adjustment feature 50, located adjacent a lower end of the carrier member 33B, by way of example and without limitation, is configured to allow cross-vehicle adjustment of the B-pillar carrier member 33B and the window 46 carried, in part, thereby. The first adjustment feature 50, in the non-limiting embodiment of FIGS. 7 and 8, includes an adjustment member, referred to hereafter as adjustment rail 58, extending laterally outwardly, along the cross-vehicle direction, from a side face 60 of the B-pillar carrier member 33B. The adjustment rail 58 can be formed as a monolithic molded piece with the B-pillar carrier member 33B. It is further contemplated that the adjustment rail 58 could be formed as a separate piece of material and then subsequently fixed to the B-pillar carrier member 33B, such as via welding, bonding and/or mechanical fasteners, for example. The adjustment rail 58 has a generally C-shaped wall portion 62, as viewed in lateral cross-section. The C-shaped wall portion 62 has a generally flat back wall 64 extending to opposite end walls 66 with lips 68 extending from the end walls 66 toward one another to free edges 70 facing one another in mirrored relation. As such, opposed guide channels, referred to hereafter simply as channels 72, are formed and bounded by a portion of the back wall 64, the end walls 66 and the lips 68. The free edges 70 are formed having a plurality of uniformly distributed teeth, such as serrated or zig-zag shaped teeth 74, wherein the teeth provide uniform ratchet surfaces opposing one another in mirrored relation, by way of example and without limitation.

The first adjustment feature 50 further includes a translatable adjuster, referred to hereafter as slide adjuster 76, a fastener 78 and a mount bracket 79. The slide adjuster 76 is configured to slidably translate along the cross-vehicle, side-to-side vehicle direction C/V within the channels 72 and to be fixed in a desired cross-vehicle C/V location, as best determined during assembly, against translation via the fastener 78 upon adjusting the B-pillar carrier member 33B to the desired cross-vehicle location. The slide adjuster 76 has opposite flange portions 80 configured for sliding receipt within the channels 72. With the flange portions 80 extending into receipt within the channels 72, the slide adjuster 76 is prevented from being pulled laterally outwardly from the channels 72 along the aft/forward vehicle direction. The slide adjuster 76 also has at least one, and shown as a plurality (pair) of oppositely facing teeth or lock cogs, also referred to as pawls 82, configured to ratchet (click or snap) along the teeth 74 during adjustment, whereupon reaching the desired cross-vehicle C/V location, the fastener 78 can be tightened to fix the first adjustment feature 50 and B-pillar carrier member 33B in the intended cross-vehicle location. The pawls 82 are shown, by way of example and without limitation, as being formed on bridges 83 extending between the opposite sides of the slide adjuster 76, wherein the bridges 83 can deflect in spring-like fashion radially inwardly to facilitate adjustment, while springing resiliently outwardly to allow the teeth 74 to engage teeth of the pawls 82 in ratchet-like fashion. It is to be recognized that the channels 72 could be provided with an increased width relative to the thickness of the flange portions 80, thereby allowing the pawls 82 to be pulled or pushed laterally out of engagement with the teeth 74 to facilitate sliding translation of the slide adjuster 76 along the channels 72, whereupon the pawls 82 can be automatically pushed or pulled back into locked engagement with the teeth 74 upon tightening the fastener 78, as will be readily appreciated by one possessing ordinary skill in the fastener arts upon viewing the present disclosure.

The mount bracket 79 is shown in a non-limiting embodiment as being generally L-shaped, having a base 84 and an adjustment arm 86 extending generally transversely from the base 84. The base 84 is provided with a through opening 88 for receipt of a fastener 90 therethrough. The fastener 90 can be provided as a standard male threaded screw or bolt, by way of example and without limitation, configured for threaded, fixed attachment to the door panel structure 17, such as to the inner panel 18, to fix the mount bracket 79 to the door panel structure 17. The adjustment arm 86 is shown having an aperture 93 configured and sized to allow a threaded shank of the fastener 78 to be received and maintained therethrough during translation of the slide adjuster 76 within the channels 72, such as about +/−10 mm in the cross-vehicle C/V directions. The adjustment rail 58 is shown having an elongate slot 92 configured to extend generally along the cross-vehicle direction. The slot 92 is sized to allow a threaded shank of the fastener 78 to slide therealong during translation of the slide adjuster 76 within the channels 72, such as about +/−10 mm in the cross-vehicle C/V directions. Upon adjusting the first slide adjuster 76 to the desired location, with the window 46 and B-pillar carrier member 33B being properly positioned in the cross-vehicle direction for example, adjusting the first slide adjuster 76 causes the B-pillar carrier member 33B being properly positioned and maintained in the cross-vehicle direction while causing pivoting of the window 46 about its fixed, or hinged connection of the B-pillar carrier member 33B at an upper position to the door panel structure 17 illustratively shown about region A of FIG. 3, such as to the inner panel 18, such that the top of the window 46 can be adjusted to mate with the roof, A-pillar, and/or B-pillar of the vehicle 10 as the B-pillar carrier member 33B is being pivoted by adjusting the first slide adjuster 76. As another example, upon adjusting the window 46 to mate with the roof, A-pillar, and/or B-pillar of the vehicle 10 the B-pillar carrier member 33B is caused to pivot about an upper position to the door panel structure 17, such as to the inner panel 18, thereby adjusting the first slide adjuster 76. Adjustment of the first slide adjuster 76 causes the B-pillar carrier member 33B and therefore the window 46 being properly positioned and maintained in the cross-vehicle direction. Upon -pillar carrier member 33B being properly positioned and maintained in the cross-vehicle direction, a nut 94 can be threaded onto the threaded shank of the fastener 78 and brought into snug, locked engagement with a face 96 of the mount bracket 79, and thereby maintaining the slide adjuster 76 and pawls 82 thereof in locked, fixed relation with the teeth 74 of the adjustment rail 58. Accordingly, when the nut 94 is in a loosened state, the slide adjuster 76, and thus the carrier member 33B, can be readily adjusted in the cross-vehicle direction, and then, upon being adjusted as desired, the nut 94 can be tightened to fix the slide adjuster 76 relative to the adjustment rail 58, thereby fixing the carrier member 33B in the desired cross vehicle position.

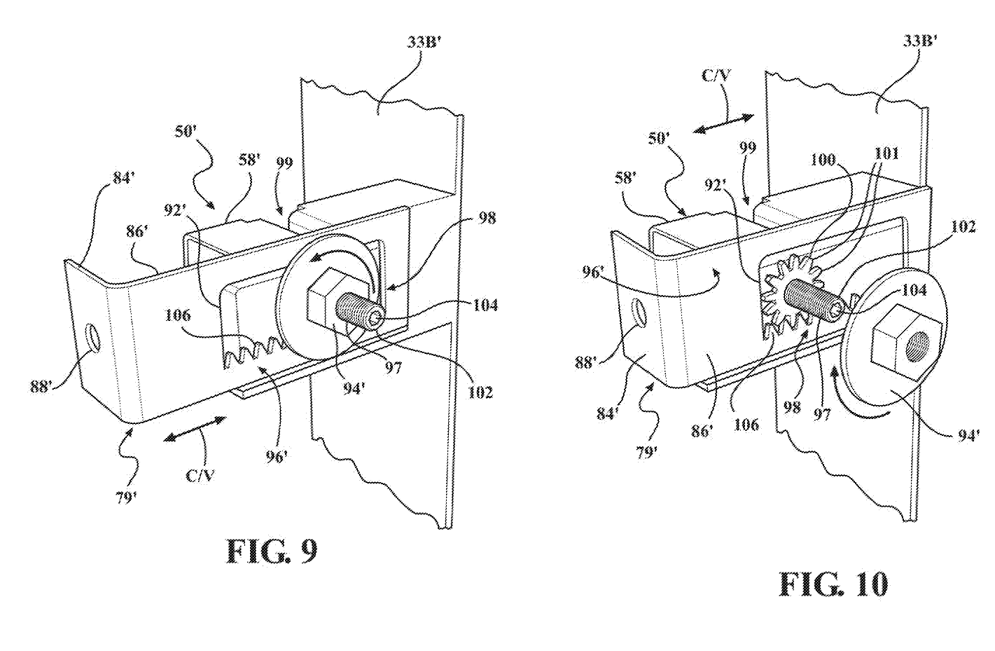

In FIGS. 9 and 10, a first adjustment feature 50′ is shown in accordance with another non-limiting embodiment, wherein the same reference numerals, offset by a prime symbol (′), are used to identify like features.

The first adjustment feature 50′, rather than having a pawl and teeth configuration, as discussed above for the embodiment 50 of FIGS. 7 and 8, has a rack and pinion configuration to effectuate translation of an adjustment rail 58′ of a B-pillar carrier member 33B′ along a mount bracket 79′. As discussed above, it is to be recognized that the adjustment rail 58′, rather than being molded as a single piece of plastic material with the B-pillar carrier member 33B′, could be formed as a separate piece of material and subsequently fixed to the B-pillar carrier member 33B′, if desired for the intended application.

The adjustment rail 58′ is provided having through opening or passage configured for captured receipt of a shaft 97 of a pinion member 98 for rotation therein. The shaft of the pinion member 98 is preferably fixed against removal from the passage 99, such a via a snap fit, spring clip, nut, cotter-pin, or the like, adjacent a first free end of the shaft 97 located on a backside of the adjustment rail 58′ (not shown), while the shaft of the pinion member 98 is free to rotate within the through opening while adjustment is being made. The pinion member 98 has a pinion gear 100 fixed to the shaft 97 between the first free end (not shown) and a second free end 102 of shaft 97. To facilitate adjustment, the shaft 97 of pinion member 98 can be provided with a tool receiver, shown as a receptacle 104 extending into the second free end 102, such as a hex-shaped receptacle, by way of example and without limitation. Those skilled in the art will readily recognize other shapes and configurations for a tool receiver that would allow a tool (not shown) having a complementary driver configuration for selectively engaging the tool receiver to facilitate rotating the pinion member 98.

The mount bracket 79′ is shown being similarly shaped as the previous mount bracket 79, having a base 84′ and an adjustment arm 86′ extending generally transversely from the base 84′. The base 84′ is provided with a through opening 88′ for receipt of a fastener (not shown) therethrough for threaded, fixed attachment to the door panel structure 17, as discussed above. The adjustment arm 86′ is shown having an aperture 92′ configured to extend generally along the cross-vehicle direction. The slot 92′ is provided with rack teeth 106 along at least one elongate edge of slot 92′, wherein the rack teeth 106 are configured for meshed engagement with teeth 101 of the pinion gear 100.

To adjust the adjustment rail 58′ and the B-pillar carrier member 33B′ fixed thereto to the desired cross-vehicle position, the pinion member 98 is rotated via a tool (not shown) by coupling the tool with the receptacle 104 and rotating the pinion gear 100 in the desired clockwise or counterclockwise directions to position the window 46 and B-pillar carrier member 33B′ in the desired cross-vehicle position. Then, upon making the desired adjustment, a nut 94′ can be threaded onto a threaded shank of the shaft 99 of pinion member 98 and brought into snug, locked engagement with a face 96′ of the mount bracket 79′, and thus, maintaining the pinion gear 100 in locked, fixed relation with the rack teeth 106 of the mount bracket 79′, thereby fixing the carrier member 33B′ in the desired cross vehicle position.

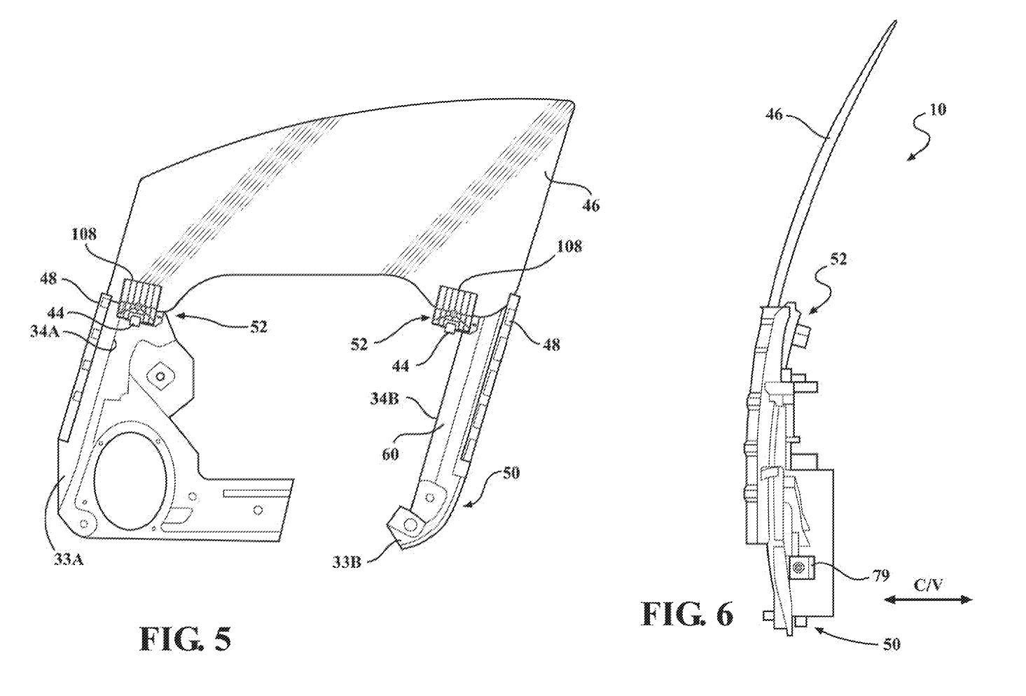

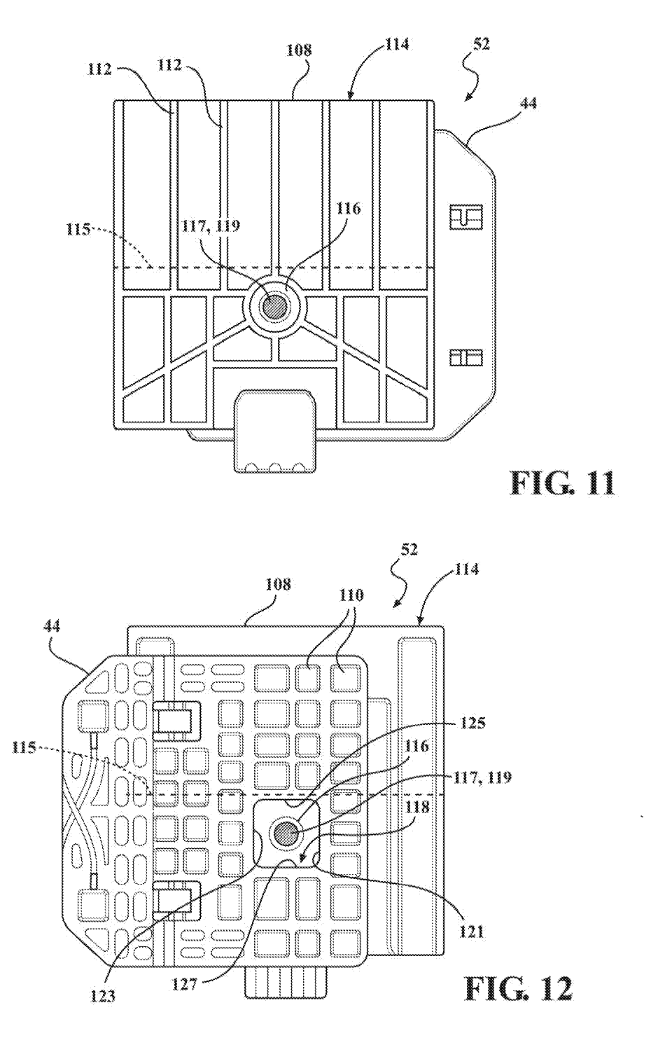

In FIGS. 11 and 12, the second adjustment feature 52 is shown in accordance with one non-limiting aspect of the disclosure, which provides adjustment between lifter plate 44 and window mount bracket 108 in the aft/forward direction A/F, and in an up/down direction U/D. The second adjustment feature 52, shown in FIG. 5 located adjacent an upper end of the carrier members 33A, 33B, wherein the upper end of the carrier members 33A, 33B can be attached to the inner panel 18 via a hinge or via a fastener, such as a bolt, by way of example and without limitation, includes the lifter plates 44 and window mount brackets 108. The lifter plates 44 and window mount brackets 108 can both be made from plastic, such as in a molding process, wherein respective strengthening ribs 110, 112 can be readily molded therein, as desired. The window mount brackets 108 have mount walls 114 (illustratively defining a mount slot depending into a top surface of mount walls 114 to a bottom surface 115, wherein the mount slot extends across the full width of mount brackets 108 for receiving a lower edge of the window 46 therein). With the bottom edge of the window 46 disposed in the mount slot, the window mount brackets 108 can bonded directly to the window 46 using a suitable plastic/glass adhesive, and thus, there is no need to form openings through the window 46, thereby doing away with a known challenge, and thus, simplifying manufacture and reducing cost. The window mount brackets 108 also have a fastener socket, such as a female threaded nut 116 fixed therein, wherein the nut 116 is located immediately beneath the bottom surface 115 of the mount slot to allow passage of fasteners 117 without interference by the bottom edge of the window 46. In an alternative the fasteners 117 is sized so as not to extend past the nuts 116 thereby allowing the window 46 to be extended below 115, to maximize the bonding contact surface area between the window 46 and the window mount brackets 108. The nuts 116 are sized for threaded receipt of fasteners 117 to fix the window mount brackets 108 to the lifter plates 44.

The lifter plates 44 are configured to slide downwardly and upwardly along the respective A-pillar and B-pillar window regulator rails 34A, 34B during a window opening and closing event. Lifter plates 44 have through openings 118 configured for a loose fit of a shank 119 of the fasteners 117 therethrough. The through openings 118 are shown, in a non-limiting embodiment, as being generally square, with respective opposite sides 121, 123 being spaced sufficiently from one another and with respective opposite sides 125, 127 being spaced sufficiently from one another to allow the shank 119 of the fastener 117 extending therethrough to be adjusted respectively in aft/forward A/F and up/down U/D directions, such as about +/−5 mm in both the aft/forward and up/down directions. Upon positioning the window 46, which is fixed to lifter plates 44, in the desired aft/forward and up/down directions, a nut (not shown) can be threaded onto the fastener 117 to fix the window mount bracket 108 against relative movement with the lifter plate 44, thereby fixing the window 46 in the desired position.

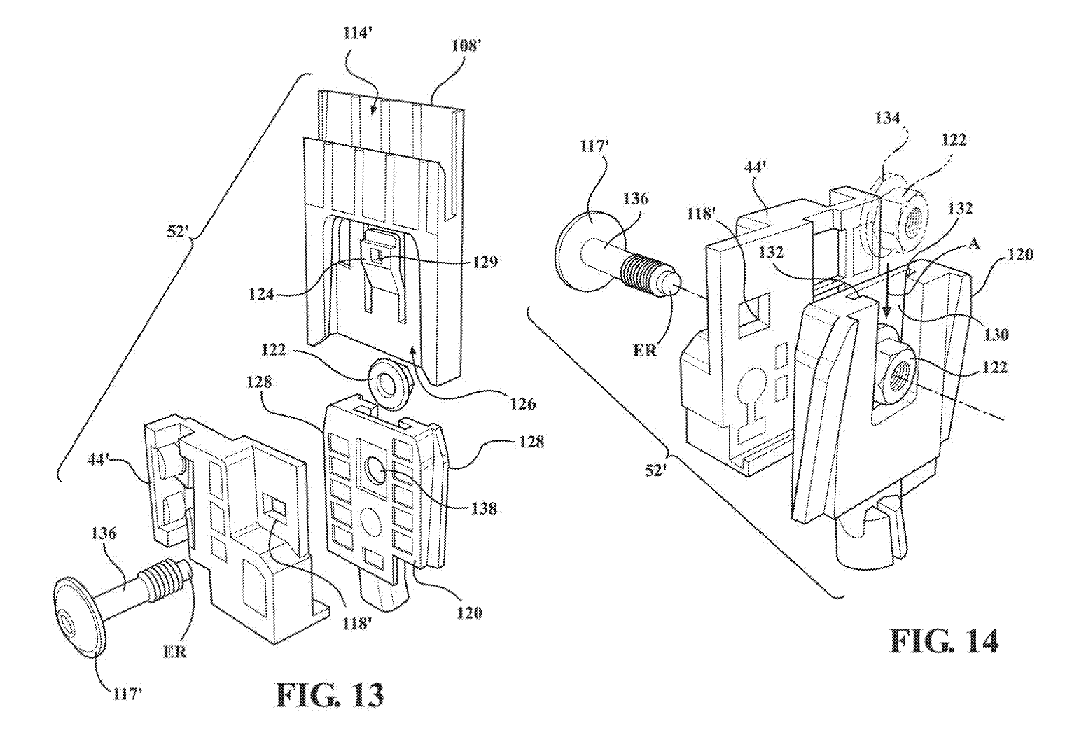

In FIGS. 13 and 14, a second adjustment feature 52′ is shown in accordance with another non-limiting embodiment, wherein the same reference numerals as used for the second adjustment feature 52, offset by a prime symbol (′), are used to identify like features.

The second adjustment feature 52′ includes a window mount bracket 108′, an intermediate connector member, also referred to as connector member, adaptor plate or adaptor 120, a lifter plate 44′ and a fastener, including a threaded bolt 117′ and a nut 122. Adaptor 120 is disposed between window mount bracket 108′ and lifter plate 44′ to facilitate relative adjustment between window mount bracket 108′ and lifter plate 44′. The window mount bracket 108′ has a recessed slot, also referred to as pocket or mount pocket 114′ configured for receipt of a bottom edge of the window 46 therein, similar to that discussed above for window mount bracket 108, wherein the a suitable plastic/glass adhesive can be used to fix the window bottom edge therein, and thus, as discussed above, there is no need to form openings through the window 46. The mount pocket 114′ extends across a full width of the window mount bracket 108′ for receipt of the edge of the window 46 between opposite walls bounding the mount pocket 114′. The window mount bracket 108′ has a spring lock slide tongue, also referred to as spring lever or spring finger, and referred to hereafter as referred to hereafter as spring lock 124, configured for sliding, locking engagement with an end region (ER) of fastener 117′. In particular, spring lock 124 has a through opening or recessed receptacle 129 sized for close fitting (slightly loose, but relatively snug) receipt of end region ER therein, thereby causing spring lock 124 to be brought into locked engagement with end region ER upon receptacle 129 of spring lock 124 snapping over end region ER such that end region ER extends into receptacle 129. As such, it is to be understood that end region ER extends outwardly from nut 122 sufficiently for receipt in recessed receptacle 129 upon fixing adaptor 120 to lifter plate 44′. The mount bracket 108′ further includes a generally C-shaped channel 126, as viewed in lateral cross-section, configured for close sliding receipt of opposite peripheral flanges 128 of the adapter 120. Accordingly, in assembly, when opposite flanges 128 are slid into the channel 126 and end region ER of fastener 117′ is disposed in locked receipt in recessed receptacle 129, the window mount bracket 108′ is fixed against movement relative to the adaptor 120. It will be appreciated by those skilled in the art of fasteners, upon viewing the disclosure herein, that the mount bracket 108′ can be intentionally and selectively released from the adaptor 120 by selectively depressing the spring lock 124 to remove end region ER from receptacle 129, and then simultaneously sliding the mount bracket 108′ along a direction opposite to that of assembly. Otherwise, without intentionally depressing the spring lock 124, the mount bracket 108′ remains fixed in locked engagement with the adaptor 120.

The adaptor 120 further includes a channel 130 configured for sliding receipt of the nut 122 along the direction of arrow A (FIG. 14). The channel 130 has opposite reduced width, laterally recessed channels, also referred to as recessed portions 132, shaped for close sliding receipt of an annular peripheral lip 134 of the nut 122 to retain the nut 122 laterally within the channel 130. Accordingly, the nut 122 is prevented from falling out of the channel 130 in a direction transverse (lateral) to the insertion direction of arrow A upon being slid therein.

The lifter plates 44′ are configured to slide along the respective A-pillar and B-pillar window regulator rails 34A, 34B, and have through openings 118′ configured for a loose, clearance fit of shank 136 of the fasteners 117′ therethrough. The through openings 118′ are shown, in a non-limiting embodiment, as being generally square, as discussed above for the through openings 118, wherein the shank 136 of the fastener 117′ is able to be adjusted aft/forward and up/down, such as about +/−5 mm in both the aft/forward A/F and up/down U/D directions. Accordingly, with the through openings 138, 118′ being concentrically aligned with one another, the window 46 is able to be adjusted in the desired aft/forward and up/down directions between about +/−5 mm in both the aft/forward and up/down directions. Then, upon adjusting the window 46 to the desired position, the nut 122, which is already in place and partially threaded on the fastener 117′, can be tightened on the fastener 117′, the nut 122 being prevented from rotating during such tightening by its engagement with the channel 130 sidewalls, to fix the window mount bracket 108′ against relative movement with the lifter plate 44′, thereby fixing the window 46 in the desired position. Alternatively, nut 122 may be overmolded with adaptor 120. With the nut 122 already being partially threaded on the fastener 117′, assembly is simplified by doing away with the need for a blind assembly of the nut 122 onto the fastener 117′, and thus, costs associated with assembly are reduced.

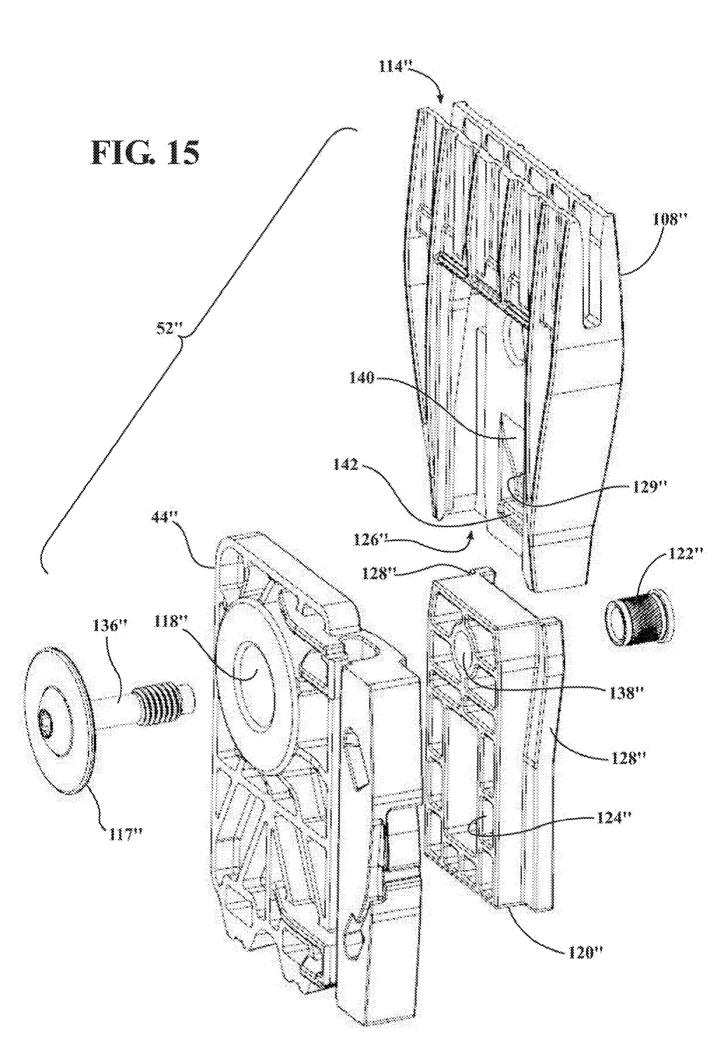

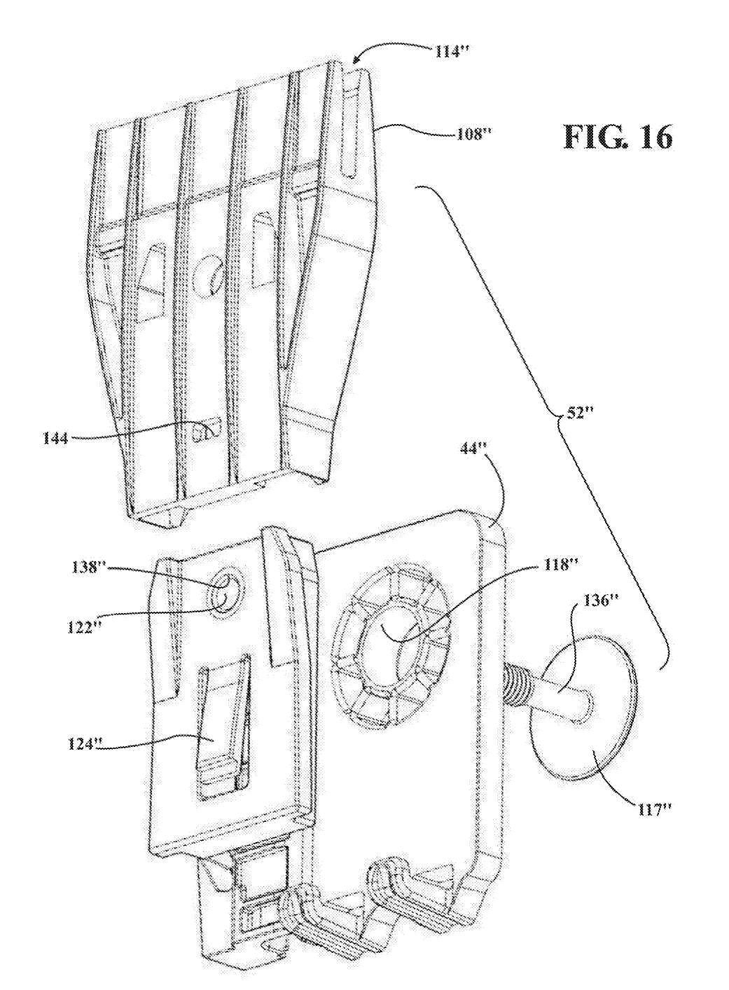

In FIGS. 15 and 16, a second adjustment feature 52″ is shown in accordance with another non-limiting embodiment, wherein the same reference numerals as used for the second adjustment feature 52′, offset by a double prime symbol (″), are used to identify like features.

The second adjustment feature 52″ includes a window mount bracket 108″, an intermediate connector, also referred to as adaptor 120″, a lifter plate 44″ and a fastener, including a threaded bolt 117″ and a nut 122″. The window mount bracket 108″ has a recessed slot, also referred to as pocket or mount pocket 114″ configured for receipt of a bottom edge of the window 46 therein, similar to that discussed above for window mount bracket 108, wherein a suitable plastic/glass adhesive can be used to fix the window bottom edge therein, and thus, as discussed above, there is no need to form openings through the window 46. The window mount bracket 108″, rather than having a spring lock slide tongue as discussed above for window mount bracket 108′, has a recessed pocket 129″ configured for locking receipt of a spring lock slide tongue, also referred to as spring lever or spring finger, and referred to hereafter as referred to hereafter as spring lock 124″ of adaptor 120″. In particular, recessed pocket 129″ has an inclined, tapered surface 140 extending to a lock shoulder 142, thereby providing the pocket 129″ with a wedge shape. The wedge shaped of recessed pocket 129″ is sized and shaped for a close fit of spring lock 124″ therein. The mount bracket 108″ further includes a generally C-shaped channel 126″ configured for close sliding receipt of opposite peripheral flanges 128″ of the adaptor 120″. Accordingly, in assembly, when opposite flanges 128″ are slid into the channel 126″ and spring lock 124″ is disposed in locked receipt in recessed receptacle 129″, the window mount bracket 108″ is fixed against movement relative to the adaptor 120″. As discussed above for mount bracket 108′, the mount bracket 108″ can be intentionally and selectively released from the adaptor 120″ by selectively depressing the spring lock 124″, such as via insertion of a tool (not shown) through an opening 144 extending into the recessed pocket 129″ through inclined surface and pushing on spring lock 124″ to deflect spring lock 124″ outwardly from recess pocket 129″. Otherwise, without intentionally depressing the spring lock 124″, the mount bracket 108″ remains fixed in locked engagement with the adaptor 120″.

The adaptor 120″ further includes an opening 138″ configured for fixed receipt of the nut 122″, such as via a press fit therein or via overmolding with the adaptor 120″. Nut 122″ has a generally cylindrical outer surface that can have retention features thereon, such a via a knurling process, by way of example and without limitation, thereby facilitating fixed receipt and anti-rotation of nut 122″ in opening 138″. It is to be understood that any suitable adhesive could be used to further ensure nut 122″ remains fixed in opening 138″.

The lifter plates 44″ are configured to slide along the respective A-pillar and B-pillar window regulator rails 34A, 34B, and have through openings 118′ configured for a loose, clearance fit of shank 136″ of the fasteners 117″ therethrough. The through openings 118″, in a non-limiting embodiment, allow the shank 136″ of the fastener 117″ to be adjusted aft/forward and up/down, such as about +/−5 mm in both the aft/forward A/F and up/down U/D directions. Accordingly, with fastener 117″ initially threaded with nut 122″, but not tightened, the window 46 is able to be adjusted in the desired aft/forward and up/down directions between about +/−5 mm in both the aft/forward and up/down directions. Then, upon adjusting the window 46 to the desired position, the nut 122″, which is already in place and partially threaded on the fastener 117″, can be tightened on the fastener 117″ to fix the window mount bracket 108″ against relative movement with the lifter plate 44″, thereby fixing the window 46 in the desired position.

In view of the structural features of the carrier module 20 discussed above and illustrated, an improved method of assembling a door assembly 10 for a motor vehicle 14 is provided. The method includes attaching outer and inner panels 16, 18 to one another to define a door panel structure 17 having an internal door cavity 22. Further, providing the carrier module 20 having a pair of carrier members 33A, 33B coupled to one another via at least one flexible member 38, e.g., cable and/or conduit and/or electrical wire, for operable communication therebetween. Then, inserting the carrier members 33A, 33B through an opening 24 of the inner panel 18 and into the internal door cavity 22, such as independently from one another, by moving a first one of the carrier members 33B through the opening 24 and into the internal door cavity 22, and then, inserting a second one of the carrier members 33A through the opening 24 and into the internal door cavity 22. Then, upon locating the carrier members 33A, 33B in the internal door cavity 22, adjusting at least one of the carrier members 33B in a cross-vehicle C/V direction via a first adjustment feature 50, 50′, and in an aft/forward A/F direction, and an up/down U/D direction via a separate second adjustment feature 52, 52′, 52″, and then fixing adjustable carrier member 33B in the desired adjusted position. The adjustment of the carrier members 33A, 33B is preferably performed by first installing a window 46 onto lifter plates 44, 44′, 44″ of the carrier members 33A, 33B and within glass run channels 48 of the carrier members 33A, 33B, and then moving the window in cross-vehicle, aft/forward, and up/down directions, as necessary to bring the window 46 into the desired position, thereby automatically causing the B-pillar carrier member 33B to adjust and be maintained at such a position accordingly, and then tightening the respective fasteners of the adjustment features 50, 50′, 52, 52′. The slide adjuster 76 being configured to ratchet (incrementally clicked or snapped) along the teeth 74 during adjustment until reaching the desired cross-vehicle C/V location, allows the B-pillar carrier member 33B to be adjusted and be maintained at such a position until the fastener 78 can be tightened to fix the first adjustment feature 50 and B-pillar carrier member 33B in the intended cross-vehicle location, thereby increasing ease and speed of installation and alignment of the window 46 for an assembler. The subsequent tightening of the respective fasteners of the adjustment features 50, 50′, 52, 52′ can be done by an assembler without having to simultaneously verifying and manually maintain the position of the B-pillar carrier member 33B and window 46. Similarly, the nut 116, 122, 122″ being partially pre-threaded on the fastener 117′ and pre-torqued to allow the window 46 and window mount bracket 108, 108′, 108″ to be adjusted in the aft/forward direction A/F, and in an up/down direction U/D relative to the lifter plate 44, but once properly positioned to be maintained in the adjusted position, for example due to frictional engagement, or other ratcheting configuration provided between the lifter plate 44 and the window mount bracket 108, and between the lifter plate 44′, 44″ and the adaptor 120, 120″.

While the above description constitutes a plurality of embodiments of the present invention, it will be appreciated that the present invention is susceptible to further modification and change without departing from the fair meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A carrier module for a motor vehicle having inner and outer panels defining a door panel structure with an internal door cavity, said carrier module, comprising:
a pair of carrier members, each carrier member extending lengthwise between opposite first and second ends, said carrier members being operably coupled to one another via at least one cable, said carrier members being configured for substantially free movement relative to one another to facilitate installation of said carrier members into the internal door cavity, wherein at least one of said carrier members has at least one adjuster allowing said at least one carrier member to be adjusted along at least one of aft/forward, up/down and cross-vehicle directions.

2. The carrier module of claim 1, wherein said at least one carrier member has a window regulator rail and a lifter plate configured for reciprocating movement along said window regulator rail between said first end and said second end, and further including a window mount bracket attached to said lifter plate and configured for fixed attachment to a window, wherein said lifter plate and said window mount bracket are adjustably moveable relative to one another to provide the at least one of aft/forward and up/down adjustment.

3. The carrier module of claim 2, further including an adaptor disposed between said lifter plate and said window mount bracket, wherein said lifter plate and said adaptor are adjustably moveable relative to one another to provide the at least one of aft/forward and up/down adjustment.

4. The carrier module of claim 3, wherein said adaptor has one of a spring lock finger and a pocket, said spring lock finger being configured to releasably lock said window mount bracket to said adaptor.

5. The carrier module of claim 4, wherein said window mount bracket has the other of said spring lock finger and said pocket, said spring lock finger being configured for slidable, releasable locking receipt in said pocket.

6. The carrier module of claim 3, wherein said window mount bracket has a mount pocket configured for fixed receipt of an edge of the window therein.

7. The carrier module of claim 2, wherein at least one of said lifter plate and said window mount bracket is formed of plastic.

8. The carrier module of claim 1, wherein said at least one carrier member has a mount bracket adjacent one of said first and second ends, said mount bracket being configured for attachment to a door panel structure, wherein said at least one carrier member and said mount bracket are adjustably moveable relative to one another to provide adjustment in the cross-vehicle direction.

9. The carrier module of claim 8, wherein said at least one carrier member has an adjustment rail extending laterally outwardly therefrom, said adjustment rail having a plurality of teeth and further including a slide adjuster operably coupled to said mount bracket and having at least one pawl configured for moveable adjustment along said plurality of teeth.

10. The carrier module of claim 8, wherein said at least one carrier member has an adjustment rail extending laterally outwardly therefrom and further including a pinion gear supported for rotation by said adjustment rail, said mount bracket having a plurality of teeth in meshed engagement with said pinion gear, wherein selective rotation of said pinion gear causes said at least one carrier member and said mount bracket to be adjustably moveable relative to one another in the cross-vehicle direction.

11. A door assembly for a vehicle, comprising:
an outer panel;
an inner panel having at least one opening, said inner panel being connected to said outer panel to form an internal door cavity; and
a carrier module including a pair of carrier members operably coupled to one another via at least one cable, said carrier members being configured for substantially free movement relative to one another to facilitate installation of said carrier members into the internal door cavity through said at least one opening formed in the inner panel, wherein at least one of said carrier members is formed of plastic.

12. The door assembly of claim 11, wherein said at least one carrier member has at least one of a window regulator rail and glass run channel formed as a single piece of plastic material therewith.

13. The door assembly of claim 12, further including a lifter plate configured for movement along said window regulator rail, said lifter plate being formed of plastic.

14. The door assembly of claim 13, wherein said lifter plate is adjustable relative to said window regulator rail along aft/forward and up/down directions.

15. The door assembly of claim 14, further including a window mount bracket configured for fixed attachment to a window, said lifter plate and said window mount bracket being configured for attachment to one another, wherein said lifter plate and said window mount bracket are configured for relative movement with one another to provide said aft/forward and up/down adjustment.

16. The door assembly of claim 15, further including an adaptor disposed between said window mount bracket and said lifter plate, said adaptor being configured for relative adjustment with said lifter plate.

17. The door assembly of claim 11, wherein said at least one carrier member is adjustable in cross-vehicle direction.

18. The door assembly of claim 17, further including a mount bracket configured for attachment to said inner panel, wherein said at least one carrier member and said mount bracket are configured for relative movement with one another to provide said cross-vehicle direction adjustment.

19. The door assembly of claim 18, wherein said at least one carrier member has a plurality of teeth and further including a slide adjuster having at least one pawl configured for slideable adjustment along said plurality of teeth.

20. The door assembly of claim 18, further including a pinion gear supported for rotation by said at least one carrier member, said mount bracket having a plurality of teeth configured in meshed engagement with said pinion gear such that rotation of said pinion gear causes said cross-vehicle direction adjustment.
